(19) United States
(12) Patent Application Publication
(10) Pub. No.: US 2010/0089150 A1
(43) Pub. Date: Apr. 15, 2010

(54) Device for Determining and/or Monitoring at Least One Process Variable

(76) Inventor: Jiri Polak, Neu St. Johann (CH)

Correspondence Address: BACON & THOMAS, PLLC, 625 SLATERS LANE, FOURTH FLOOR, ALEXANDRIA, VA, 22314-1176, US

(21) Appl. No.: 12/086,610

(22) PCT Filed: Dec. 12, 2006
(86) PCT No.: PCT/EP2006/069599

§ 371 Date: May 8, 2009

(30) Foreign Application Priority Data
Dec. 22, 2005 (DE) 102005062005.1

(51) Int. Cl. G01N 27/12

(52) U.S. Cl. 73/335.02

(57) ABSTRACT

An apparatus for determining and/or monitoring at least one process variable, especially the moisture content or the temperature of a medium, including at least one sensor unit. A supply canal is provided, and the supply canal is embodied, positioned and matched at least to the sensor unit in such a manner that the medium has access through the supply canal essentially only to the sensor unit.

The invention relates to an apparatus for determining and/or monitoring at least one process variable, especially the moisture content or temperature of a medium, wherein the apparatus includes at least one sensor unit. The medium can be, for example, a liquid, a gas or a vapor, while the process variable is, for example, moisture content, temperature, density or flow, e.g. flow rate, of the medium.

In the case of measuring devices for measuring moisture content or temperature of a medium, it is known in the state of the art, to apply sensor units produced by thin film, or thick film, technologies. In such case, either capacitors are produced, whose dielectric reacts to moisture content, or resistor structures are applied to a carrier, with the electrical resistance depending on temperature. These sensor elements usually have very small dimensions. For electrical contacting, electrical current supply and simply also for bringing the sensor elements into the measuring environment, the sensor units are usually secured on a circuit board and, with this, then placed in a measurements housing. The housing is usually provided with openings, so that the medium can get to the sensor unit. A problem associated therewith is that the moisture in the medium may condense on the inner walls of the housing, or on other components of the measuring device. Depending on the construction of the circuit board, it is also possible that the circuit board may collect moisture. Thus, a microclimate may form, which can compromise or even corrupt the measurements of the sensor.

In the state of the art (WO 00/28311) it is known to arrange the sensor element over a cut-out in the supporting circuit board, and to coat the circuit board and edges of the cut-out with a film resistant to moisture. This method does not, however, prevent moisture from condensing in the measuring device.

An object of the invention is, thus, to provide a measuring device, which is distinguished by a marked reduction of internal condensation of moisture from a medium, in order, especially, to prevent condensate from affecting measurements.

The object is achieved by the invention by features including that: At least one supply canal is provided, and that the supply canal is embodied, positioned and matched at least to the sensor unit in such a manner, that the medium accesses essentially only the sensor unit through the supply canal. In the state of the art, it is known to provide access for the medium to the sensor unit through an opening in the measuring device. The invention is distinguished by the fact that the medium gets essentially only to the sensor unit through the supply canal and not into other internal space of the measuring device. Thus, it is prevented, that the medium and, thus also its moisture, penetrates into remaining internal space of the measuring device, where the moisture could condense.

An embodiment of the invention provides that: The sensor unit has at least one at least partially active surface, which is active for measuring the process variable and/or for measuring at least one measured variable dependent on the process variable; and the supply canal leads the medium essentially only to the active surface. On the sensor unit, there is usually applied, on one side, at least one structure, which serves for the actual measuring. In the case of a temperature sensor, this is, for example, an electrical resistance, whose resistance value is temperature dependent. Temperature, as process variable to be ascertained or monitored, is, thus, measured via the measured variable, electrical resistance, which is dependent on temperature. Via such a temperature sensor, it is additionally also possible to measure flow of a medium, or its density. In the case of a moisture sensor, there is applied on the active side of the sensor a capacitor, whose capacitance as a function of the dielectric is a measure for the moisture content. Thus, capacitance is the measured variable for ascertaining the process variable, moisture content. If only one side of the sensor is active, or essential, for the measuring, then, in an embodiment, at least one seal is provided, which is applied on the side, which faces away from the active side, and which seals the supply canal above the sensor element. In an embodiment, a cut-out is provided in the circuit board. The sensor element is, in an embodiment, arranged above the cut-out and the supply canal extends through the cut-out to the sensor element. In a further embodiment, the sensor element is located in the cut-out. Associated therewith is the embodiment wherein the supply canal is sealed with a cover behind the rear-side of the sensor unit. The sensor element is, in another embodiment, applied to the surface of the circuit board and the supply canal opens on the sensor element and, thus, above the circuit board.

An embodiment of the invention includes, that the sensor unit is connected at least partially with at least one circuit board. A circuit board frequently serves for accommodating a sensor unit. Located on the circuit board are the electrical contacts and the additional components for operation of the measuring device or sensor unit.

An embodiment of the invention provides, that the sensor unit is connected at least partially with the circuit board as an SMD-component or with flip-chip technology. There are, in the state of the art, a number of options for contacting a sensor unit with the circuit board mechanically and electrically. Thus, the sensor element can be applied to the circuit board as an SMD-component or the sensor element can be contacted via tape.

An embodiment of the invention includes, that the supply canal is embodied in such a manner, that the supply canal at least partially prevents, that the medium accesses the circuit board. Through the embodiment of the supply canal, it is, thus, especially prevented, that moisture can reach the circuit board. Since the circuit board carries the sensor element and, therewith, the circuit board is closest to the sensor element, it must especially be prevented, that moisture condenses there.

An embodiment of the invention provides that an end of the supply canal opens on, or at a slight distance from, the sensor unit. In an embodiment, such end opens on, or at a slight distance from, the active side of the sensor unit. Through these two embodiments, care is taken, that the fraction of the inner space of the measuring device reached by the medium is as small possible. Especially, lateral escape and entering of medium out of and into the supply canal, respectively, in the region of the transition to the sensor element should be prevented or at least reduced. Therefore, contact should be as direct as possible. In such case, it is, however, to be heeded that the active side, thus the side relevant for the measuring, is not adversely affected by the supply canal.

An embodiment of the invention includes, that at least one removal canal is provided, and that the removal canal is embodied, positioned and at least matched to the supply canal and/or to the sensor in such a manner, that the removal canal removes the medium essentially opposite to a supply direction of the supply canal. In an embodiment, the supply canal and the removal canal lie opposite to one another. Thus, the medium enters through the supply canal into the measuring device, is led to the sensor element and then is removed through the removal canal back out of the measuring device.

An embodiment of the invention provides, that the supply canal and the removal canal are embodied and matched to one another in such a manner, that the supply canal and the removal canal prevent, that the medium can have access into the region of the circuit board. Penetration of the medium into the interior of the measurements housing must also be prevented after the passing of the sensor element, i.e. also after the measuring. The removal canal is appropriately embodied for such purpose. Furthermore, however, also the transition region between supply canal and removal canal is to be suitably designed.

An embodiment of the invention includes, that at least one housing is provided, in which the sensor unit and the supply canal are at least partially located. The housing surrounds the sensor unit, serves to protect it from mechanical influences and presents also the outward appearance of the measuring device. In an embodiment, the sensor unit is arranged essentially in the middle of the housing. Thus, for example, mechanical loading of the medium or measuring environment or process are kept by the housing, as much as possible, largely away from the sensor unit.

An embodiment of the invention provides that the supply canal is embodied in such a manner, that it prevents, that the medium has access to the interior of the housing, except to the sensor unit. As already above described, the medium should travel through the supply canal only to the sensor unit, and, especially, it should be prevented, that the sensor unit gets outside the area of the sensor unit into the remaining inner space of the housing. Especially, the supply canal is embodied of such a material, that the taking on of moisture or, especially, release of moisture is prevented. This is applies also to the removal canal.

An embodiment of the invention includes, that the supply canal is embodied as one-piece with the housing or with the circuit board. The supply canal is, thus, in an embodiment, manufactured with the housing as one component, for example, such component is injection molded.

An embodiment of the invention provides that the sensor unit measures moisture content and/or temperature and/or flow of the medium. The measuring device serves, thus, for example, for measuring moisture content, temperature, density or mass flow of the medium.

An embodiment of the invention includes, that the sensor unit is manufactured, at least in part, with thin film technology or with thick film technology.

The invention will now be explained in greater detail on the basis of the appended drawing, the figures of which show as follows:

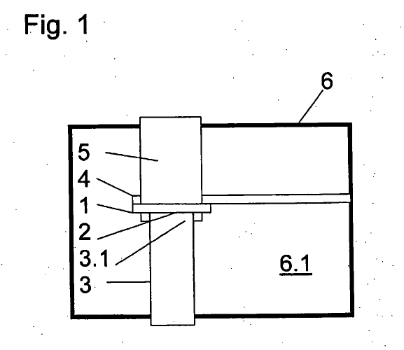

FIG. 1 an elevational section through an apparatus of the invention;

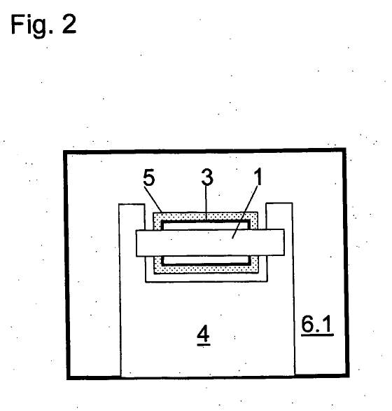

FIG. 2 a horizontal section through an apparatus of the invention according to FIG. 1; and

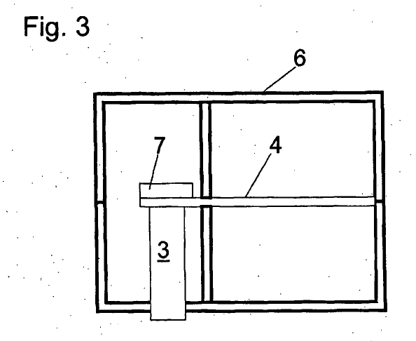

FIG. 3 an elevational section through a further embodiment of the apparatus of the invention.

FIG. 1 shows an elevational section through the apparatus of the invention. The apparatus is, here, a measuring device for measuring and/or monitoring process variables such as moisture content, temperature or flow of a medium. The medium is, in such case, at least in part, a liquid, a vapor, a gas, or any other flowable medium. Furthermore, the process variable can also be other chemical or biological process variables of the medium.

The actual measuring is executed by the sensor unit 1, whose sensor element is manufactured, for instance, with thin film technology or thick film technology. Examples of the sensor element include a temperature dependent resistance element or a capacitive element, whose dielectric reacts to the moisture content of the medium. If the sensor unit 1 serves—such as shown in the example here—for measuring moisture content of the medium (not shown), then, preferably, a layer sensitive to moisture content is located on the active side 2 of the sensor unit 1. In such case, at least one electrical, characteristic variable of the sensor unit 1, such as, for example, capacitance, changes as a function of the moisture content.

Especially in the case of measurement of moisture content, problems are created, when the medium condenses in the measuring device, or a variable microclimate forms there. This can, in particular cases, lead to corruption of the measurement. A critical area in this regard is especially the circuit board 4, via which, on the one hand, the electrical contacting of the sensor unit 1 is effected, and, on the other hand, also its affixing is accomplished. Many materials used for circuit boards are so composed they collect moisture and then, as conditions change, they subsequently release such moisture. Therefore, the circuit board 4 is a source of danger for the accuracy of the measured values. Furthermore, the circuit board 4 is, in the general, populated with components (not shown), which, most often, produce heat. Therefore, heat transfer from the components to the medium should also be prevented, as much as possible.

The sensor unit 1 is usually surrounded by a protective housing 6, which, in the state of the art, has larger openings for penetration of the medium. Since the medium, in the state of the art, penetrates into the inner space 6.1 of the housing 6, the medium or especially its moisture can also be taken up by the circuit board 4. In order that a corruption of the measuring not occur, it is known in the state of the art (WO 00/28311), to provide the area of the circuit board 4, with which the sensor unit 1 has direct contact, with a coating resistant to moisture. Moreover it is well known in the state of the art, to position the sensor unit 1 or a correspondingly moisture-sensitive component over a cut-out in the circuit board 4. This method of the state of the art reduces the effect of condensate on the sensor unit 1, but, in general, does not prevent formation of condensate, nor that the medium is influenced by heat transfer from the electronic components.

The invention provides, for solution of these problems, that the medium gets to the sensor unit 1 only via a supply canal 3. Especially, the medium accesses the active side 2 of the sensor unit 1. In the invention, thus, the medium has access not to the entire housing, but, instead, is guided directly to the sensor unit 1. As illustrated in FIG. 1, sensor unit is located, in such case, especially centrally in the housing 6. The supply canal 3 is, in such case, embodied in such a manner, that it performs also a sealing function relative to the inner space 6.1 of the housing 6. Since, thus, the medium cannot reach the circuit board 4, then also no moisture can condense there. Especially, the materials are selected taking into consideration their moisture uptake and release characteristics (absorption, adsorption or desorption).

FIG. 1 shows, especially, an embodiment, wherein, additionally, a removal canal 5 is provided, via which the medium, after leaving the supply canal 3 and passing by the sensor unit 1, then leaves the housing. The task, whether it be the supplying or the removing of the medium, is, in such case, interchangeable to the extent desired.

For sealing, the removal canal 5 protrudes here a little over the sensor unit 1 and the upper end 3.1 of the supply canal 3. The supply canal 3 opens, in such case, directly at the sensor unit 1 (to the extent there is no sensitive zone of the active region 2 of the sensor unit 1 located there), or at an as small as possible spacing from the sensor unit 1, so that lateral escape of the medium is minimized. The removal canal 5 is slightly capped over the supply canal 3 and so seals further. The medium enters, thus, essentially perpendicularly to the housing 6, through the supply canal 3 and then leaves the housing, on a straight path, through the removal canal 5. A free spreading of the medium in the inner space 6.1 is, however, prevented by the two canals 3, 5.

With this invention, it is, thus, achieved, that the medium essentially only has access to the sensor unit 1.

FIG. 2 is a plan view onto the region shown in FIG. 1. As can be seen, the supply canal 3 and the removal canal 5 extend here through a cut-out in the circuit board 4. The supply canal 3 opens onto the sensor unit 1. Its cross sectional area is, in such case, so selected, that the medium can flow laterally past the sensor unit 1. Escape of the medium into the housing 6 is prevented by the removal canal 5, which surrounds the end 3.1 of the supply canal 3 facing the sensor unit 1.

The sensor unit 1 is supported here on the circuit board 4 and is contacted therewith. Instead of this sensor unit 1 embodied, for example, as an SMD-component, such can also be affixed and contacted via mounted tapes in flip-chip technology.

FIG. 3 is an elevational section through a further embodiment of the apparatus of the invention. The housing 6, in this case, is embodied in two-parts, a lower half and an upper half. Furthermore, these two halves have walls, which are already known in the state of the art and which cooperate to isolate the section with the sensor unit 1 from the remainder of the electronics (not shown). These walls offer here an additional protection, but can however also now be omitted due to the targeted delivery obtained by the structure of the invention.

In the case of FIG. 3, only a supply canal 3 is provided, which has a seal 7 on the oppositely lying side. Thus, the medium is not removed via an additional removal canal, but, instead, removal happens via the supply canal 3 itself, or the medium remains in the supply canal 3. The illustrated seal 7 is located above the circuit board 4 and, especially, above the sensor element 1. Thus, the seal 7 acts quasi as a lid for the supply canal 3. The cross sectional area of the seal 7 is then selected, such that the medium can, it is true, get to the sides of the sensor unit 1, but cannot, however, escape into the housing 6. Also here, the seal 7 is slightly capped over the supply canal 3 and seals around it.

For putting the invention into practice, a number of variations are available: The supply canal 3 (corresponding is true for the removal canal) is a part of the housing; or it is a part of the circuit board; or it is provided in the form of a supplemental, snap-in part, which is introduced between housing 6 and circuit board 4.

### LIST OF REFERENCE CHARACTERS

TABLE 1

| | |
|---|---|
| 1 | sensor unit |
| 2 | active surface |
| 3 | supply canal |
| 3.1 | end of supply canal |
| 4 | circuit board |
| 5 | removal canal |
| 6 | housing |
| 6.1 | inner space of housing |
| 7 | seal |

1-13. (canceled)

14. An apparatus for determining and/or monitoring at least one process variable, especially moisture content or temperature, of a medium, comprising:
at least one sensor unit, and
at least one supply canal supply canal, wherein:
said supply canal is embodied, positioned and matched at least to said sensor unit in such a manner that the medium, in moving through said supply canal, accesses essentially only said sensor unit.

15. The apparatus as claimed in claim 14, wherein:
said sensor unit has at least one at least partially active surface, which is active for measuring the process variable and/or for measuring at least one measured variable dependent on the process variable; and
said supply canal leads the medium essentially only to said active surface.

16. The apparatus as claimed in claim 14, further comprising:
at least one circuit board, wherein:
said sensor unit is connected, at least partially, with said at least one circuit board.

17. The apparatus as claimed in claim 16, wherein:
said sensor unit is connected, at least partially, with said circuit board as an SMD-component or in flip-chip technology.

18. The apparatus as claimed in claim 16, wherein:
said supply canal is embodied in such a manner, that said supply canal, at least partially, prevents that the medium accesses said circuit board.

19. The apparatus as claimed in claim 14, wherein:
said supply canal opens onto said sensor unit with an end or at a small distance from said sensor unit.

20. The apparatus as claimed in claim 14, further comprising:
at least one removal canal, wherein:
said removal canal is embodied, positioned and matched at least to said supply canal and/or to said sensor unit in such a manner, that said removal canal removes the medium essentially opposite to a supply direction of said supply canal.

21. The apparatus as claimed in claim 20, wherein:
said supply canal and said removal canal are embodied and matched to one another in such a manner, that said supply canal and said removal canal prevent, the medium from having access to a region of said circuit board.

22. The apparatus as claimed in claim 14, further comprising:
at least one housing wherein:
said sensor unit and said supply canal are at least partially located in said at least one housing.

23. The apparatus as claimed in claim 22, wherein:
said supply canal is embodied in such a manner, that it prevents, the medium, with the exception of said sensor unit, from accessing an inner space of said housing.

24. The apparatus as claimed in claim 17, wherein:
said supply canal is embodied as one-piece with said housing or with said circuit board.

25. The apparatus as claimed in claim 14, wherein:
said sensor unit measures moisture content and/or temperature and/or flow of the medium.

26. The apparatus as claimed in claim 14, wherein:
said sensor unit is manufactured, at least partially, with thin film technology or with thick film technology.
